(19) United States
(12) Patent Application Publication
(10) Pub. No.: US 2006/0127860 A1
(43) Pub. Date: Jun. 15, 2006

(54) Producing a base for accurately receiving dental tooth models

(76) Inventor: Huafeng Wen, Redwood City, CA (US)

Correspondence Address: MORRISON & FOERSTER LLP, 755 PAGE MILL RD, PALO ALTO, CA, 94304-1018, US

(21) Appl. No.: 11/013,159

(22) Filed: Dec. 14, 2004

(51) Int. Cl. A61C 11/00; A61C 19/00

(52) U.S. Cl. 433/213; 433/74

(57) ABSTRACT

Systems and method for producing a base configured to receive the physical tooth models by acquiring the coordinates of the physical tooth models in the physical dental arch model using a mechanical location device and determining the configurations of first features affixed to the physical tooth models. The method further determines the locations of second features in the base in accordance with the coordinates of the physical tooth models in the physical dental arch model and the configurations of the first features. The second features are configured to receive the first features affixed to the physical tooth models.

### CROSS-REFERENCES TO RELATED INVENTIONS

The present invention is related to concurrently filed and commonly assigned U.S. patent application Ser. No. 10/______, titled “A base for physical dental arch model” by Huafeng Wen, concurrently filed and commonly assigned U.S. patent application Ser. No. 10/______, titled “Accurately producing a base for physical dental arch model” by Huafeng Wen, concurrently filed and commonly assigned U.S. patent application Ser. No. 10/______, titled “Fabricating a base compatible with physical dental tooth models” by Huafeng Wen, concurrently filed and commonly assigned U.S. patent application Ser. No. 10/______, titled “Producing non-interfering tooth models on a base” by Huafeng Wen, concurrently filed and commonly assigned U.S. patent application Ser. No. 10/______, titled “System and methods for casting physical tooth model” by Huafeng Wen, and concurrently filed and commonly assigned U.S. patent application Ser. No. 10/______, titled “Producing accurate base for dental arch model” by Huafeng Wen.

The present invention is also related to U.S. patent application Ser. No. 10/______, titled “Method and apparatus for manufacturing and constructing a physical dental arch model” by Huafeng Wen, Nov. 1, 2004, U.S. patent application Ser. No. 10/______, titled “Method and apparatus for manufacturing and constructing a dental aligner” by Huafeng Wen, Nov. 1, 2004, U.S. patent application Ser. No. 10/______, titled “Producing an adjustable physical dental arch model” by Huafeng Wen, Nov. 1, 2004, and U.S. patent application Ser. No. 10/______, titled “Producing a base for physical dental arch model” by Huafeng Wen, Nov. 1, 2004. The disclosure of these related applications are incorporated herein by reference.

### TECHNICAL FIELD

This application generally relates to the field of dental care, and more particularly to a system and a method for manufacturing and constructing a physical dental arch model.

### BACKGROUND

Orthodontics is the practice of manipulating a patient's teeth to provide better function and appearance. In treatments using fixed appliance, brackets are bonded to a patient's teeth and coupled together with an arched wire. The combination of the brackets and wire provide a force on the teeth causing them to move. Once the teeth have moved to a desired location and are held in a place for a certain period of time, the body adapts bone and tissue to maintain the teeth in the desired location. To further assist in retaining the teeth in the desired location, a patient may be fitted with a retainer.

To achieve tooth movement, orthodontists and dentists typically review patient data such as X-rays and models such as impressions of teeth. They can then determine a desired orthodontic goal for the patient. With the goal in mind, the orthodontists place the brackets and/or bands on the teeth and manually bend (i.e., shape) wire, such that a force is asserted on the teeth to reposition the teeth into the desired positions. As the teeth move towards the desired position, the orthodontist makes continual adjustments based on the progress of the treatment.

U.S. Pat. No. 5,518,397 issued to Andreiko, et. al. provides a method of forming an orthodontic brace. Such a method includes obtaining a model of the teeth of a patient's mouth and a prescription of desired positioning of such teeth. The contour of the teeth of the patient's mouth is determined, from the model. Calculations of the contour and the desired positioning of the patient's teeth are then made to determine the geometry (e.g., grooves or slots) to be provided. Custom brackets including a special geometry are then created for receiving an arch wire to form an orthodontic brace system. Such geometry is intended to provide for the disposition of the arched wire on the bracket in a progressive curvature in a horizontal plane and a substantially linear configuration in a vertical plane. The geometry of the brackets is altered, (e.g., by cutting grooves into the brackets at individual positions and angles and with particular depth) in accordance with such calculations of the bracket geometry. In such a system, the brackets are customized to provide three-dimensional movement of the teeth, once the wire, which has a two dimensional shape (i.e., linear shape in the vertical plane and curvature in the horizontal plane), is applied to the brackets.

Other innovations relating to bracket and bracket placements have also been patented. For example, such patent innovations are disclosed in U.S. Pat. No. 5,618,716 entitled “Orthodontic Bracket and Ligature” a method of ligating arch wires to brackets, U.S. Pat. No. 5,011,405 “Entitled Method for Determining Orthodontic Bracket Placement,” U.S. Pat. No. 5,395,238 entitled “Method of Forming Orthodontic Brace,” and U.S. Pat. No. 5,533,895 entitled “Orthodontic Appliance and Group Standardize Brackets therefore and methods of making, assembling and using appliance to straighten teeth”.

Kuroda et al. (1996) Am. J. Orthodontics 110:365-369 describes a method for laser scanning a plaster dental cast to produce a digital image of the cast. See also U.S. Pat. No. 5,605,459. U.S. Pat. Nos. 5,533,895; 5,474,448; 5,454,717; 5,447,432; 5,431,562; 5,395,238; 5,368,478; and 5,139,419, assigned to Ormco Corporation, describe methods for manipulating digital images of teeth for designing orthodontic appliances.

U.S. Pat. No. 5,011,405 describes a method for digitally imaging a tooth and determining optimum bracket positioning for orthodontic treatment. Laser scanning of a molded tooth to produce a three-dimensional model is described in U.S. Pat. No. 5,338,198. U.S. Pat. No. 5,452,219 describes a method for laser scanning a tooth model and milling a tooth mold. Digital computer manipulation of tooth contours is described in U.S. Pat. Nos. 5,607,305 and 5,587,912. Computerized digital imaging of the arch is described in U.S. Pat. Nos. 5,342,202 and 5,340,309.

Other patents of interest include U.S. Pat. Nos. 5,549,476; 5,382,164; 5,273,429; 4,936,862; 3,860,803; 3,660,900; 5,645,421; 5,055,039; 4,798,534; 4,856,991; 5,035,613; 5,059,118; 5,186,623; and 4,755,139.

U.S. Pat. No. 5,431,562 to Andreiko et al. describes a computerized, appliance-driven approach to orthodontics. In this method, first certain shape information of teeth is acquired. A uniplanar target arcform is calculated from the shape information. The shape of customized bracket slots, the bracket base, and the shape of the orthodontic archwire, are calculated in accordance with a mathematically-derived target archform. The goal of the Andreiko et al. method is to give more predictability, standardization, and certainty to orthodontics by replacing the human element in orthodontic appliance design with a deterministic, mathematical computation of a target arch form and appliance design. Hence the '562 patent teaches away from an interactive, computer-based system in which the orthodontist remains fully involved in patient diagnosis, appliance design, and treatment planning and monitoring.

More recently, removable appliances from companies such as Align Technology, Inc. began offering transparent, removable aligning devices as a new treatment modality in orthodontics. In this system, an impression model of the dentition of the patient is obtained by the orthodontist and shipped to a remote appliance manufacturing center, where it is scanned with a CT scanner. A computer model of the dentition in a target situation is generated at the appliance manufacturing center and made available for viewing to the orthodontist over the Internet. The orthodontist indicates changes they wish to make to individual tooth positions. Later, another virtual model is provided over the Internet and the orthodontist reviews the revised model, and indicates any further changes. After several such iterations, the target situation is agreed upon. A series of removable aligning devices or shells are manufactured and delivered to the orthodontist. The shells, in theory, will move the patient's teeth to the desired or target position.

### SUMMARY OF THE INVENTION

Systems and methods are disclosed that provide a practical, effective and efficient methods and apparatus to manufacture and construct the physical dental arch model.

In one aspect, the present invention relates to a method for producing a base configured to receive physical tooth models, comprising:

acquiring the coordinates of the physical tooth models in the physical dental arch model using a mechanical location device;

determining the configurations of first features affixed to the physical tooth models; and

determining the locations of second in the base in accordance with the coordinates of the physical tooth models in the physical dental arch model and the configurations of the first features, wherein the second features are configured to receive the first features affixed to the physical tooth models.

In another aspect, the present invention relates to a method for producing a base configured to receive the physical tooth models, including:

acquiring the coordinates of the physical tooth models in the physical dental arch model from the impression of a patient's arch using a mechanical location device; and

determining the locations of the physical tooth models in the base in accordance with the coordinates of the physical tooth models in the physical dental arch model.

In yet another aspect, the present invention relates to a physical dental arch model, including:

one or two physical tooth models each including a tooth portion and two or more first features affixed to the bottom of the tooth portion; and

a base including a plurality of second features configured to receive first features affixed to the physical tooth models, wherein the locations of the second features are determined by the coordinates acquired from the impression of a patient arch using a mechanical location device.

Embodiments may include one or more of the following advantages. An advantage of the present invention is that a physical base can be produced with accurate socket positions for receiving physical tooth models affixed with pins. The socket positions are accurately determined by coordinates acquired by a location device from the impression of a patient's arch.

Another advantage of the present invention is that the same physical tooth models can be used to form different tooth arch models having different teeth configurations. The tooth models can be reused as tooth positions are changed during an orthodontic treatment. Much of the cost of making multiple tooth arch models in orthodontic treatment is therefore eliminated.

The physical tooth models include features to allow them to be attached, plugged or locked to a base. The physical tooth models can be pre-fabricated having standard registration and attaching features for assembling. The physical tooth models can be automatically assembled onto a base by a robotic arm under computer control.

The physical dental arch model obtained by the disclosed system and methods can be used for various dental applications such as dental crown, dental bridge, aligner fabrication, biometrics, and teeth whitening. The arch model can be assembled from segmented manufacturable components that can be individually manufactured by automated, precise numerical manufacturing techniques.

Another advantage of the present invention is that the same base can support different tooth arch models having different teeth configurations. The base can include more than one set of receiving features that can receive tooth models at different positions. The reusable base further reduces cost in the dental treatment of teeth alignment.

Yet another advantageous feature of the disclosed system and methods is that the physical tooth models in the physical dental arch model can be easily separated, repaired or replaced, and reassembled after the assembly without the replacement of the whole arch model.

Simplicity is another advantage of the disclosed system and methods. The manufacturable components can be attached to a base. The assembled physical dental arch model specifically corresponds to the patient's arch. There is no need for complex and costly mechanisms such as micro-actuators for adjusting multiple degrees of freedom for each tooth model. The described methods and system is simple to make and easy to use.

The details of one or more embodiments are set forth in the accompanying drawing and in the description below. Other features, objects, and advantages of the invention will become apparent from the description and drawings, and from the claims.

### BRIEF DESCRIPTION OF THE DRAWINGS

The accompanying drawing, which are incorporated in and form a part of this specification, illustrate embodiments of the invention and, together with the description, serve to explain the principles of the invention:

FIG. 1 is a flow chart for producing a physical dental arch model in accordance with the present invention.

FIG. 2 illustrates a tooth model and a base respectively including complimentary features for assembling the tooth model with the base.

FIG. 3 illustrates fixing a stud to a tooth model including a female socket to produce a tooth model having a protruded stud.

FIG. 4 illustrate a tooth model including two pins that allow the tooth model to be plugged into two corresponding holes in a base.

FIG. 5 illustrate a tooth model including a protruded pin that allows the tooth model to be plugged into a hole in a base.

FIG. 6 illustrates cone shaped studs protruded out of the bottom of a tooth model.

FIG. 7 illustrates exemplified shapes for the studs at the bottom of a tooth model.

FIG. 8A illustrates an example of a base including a plurality of female sockets for receiving a plurality of tooth models for forming a physical dental arch model.

FIG. 8B illustrates another example of a base including a plurality of female sockets for receiving a plurality of tooth models for forming a physical dental arch model.

FIG. 9 illustrates a tooth model that can be assembled to the base in FIGS. 8A and 8B.

FIG. 10 illustrates an example of a mechanical location device for acquiring the coordinates of the physical tooth models.

### DESCRIPTION OF INVENTION

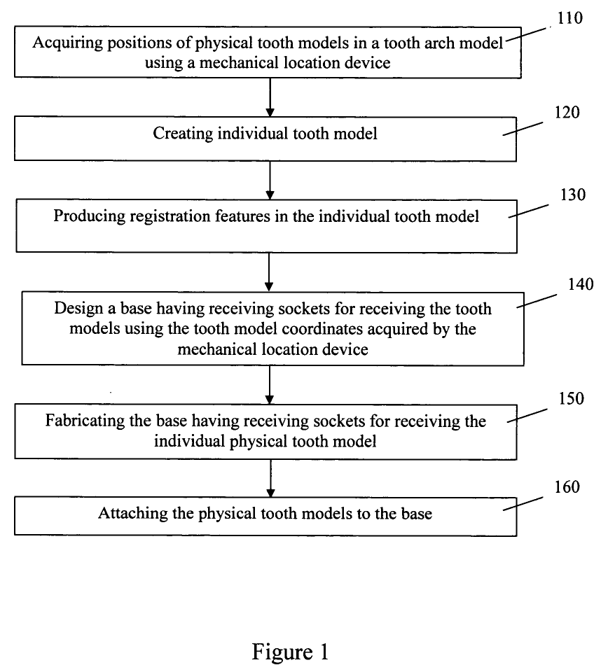

Major operations of producing a physical dental arch model are illustrated in FIG. 1. The process generally includes the following operations. The positions of physical tooth models in a tooth arch model are acquiring using a mechanical location device in step 110. First individual tooth model is created in step 120. An individual tooth model is a physical model that can be part of a physical tooth arch model, which can be used in various dental applications. Registration features are next added in step 130 to the individual tooth model to allow them to be attached to each other or a base. A base is designed having receiving sockets for receiving the tooth models using the tooth model positions acquired mechanical location device in step 140. A base is fabricated in step 150. the base includes receiving sockets for receiving the individual physical tooth model. The tooth models are finally attached to the base at the predetermined positions using the pre-designed features in step 160.

Details of process in FIG. 1 are now described. The positions of physical tooth models in a tooth arch model are first acquired using a mechanical location device (step 110).

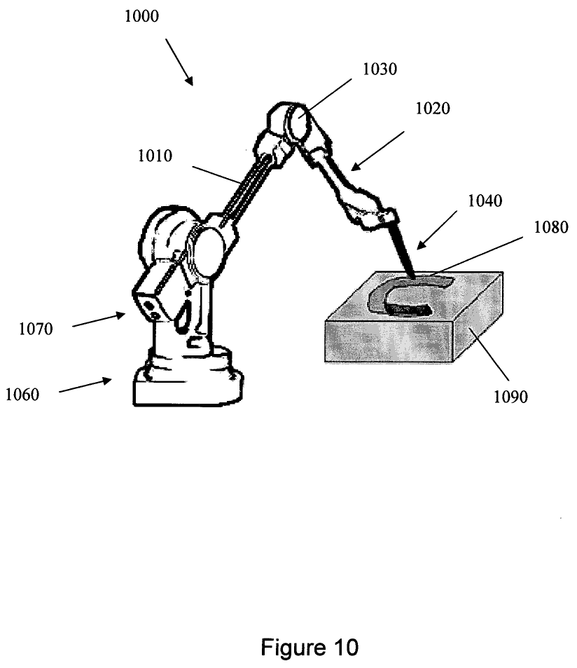

As shown in FIG. 10, a dental impression 1080 of a patient's arch is first made using a pre-designed container 1090. The impression is fixed in the container using an epoxy. The relative positions of the patient teeth are measured off the impression using a mechanical location device 1000. An example of a mechanical location device is the Microscribe available from Immersion and Phantom. Microscribe is a hand-held 3D digitizers that can develop a digital computer model for an existing 3D object. As shown in FIG. 10, the mechanical location device 1000 includes mechanical arms 1010, 1020 having one or more mechanical joints 1030. The mechanical joint 1030 is equipped with precision bearings for smooth manipulation and internal digital optical sensors for decoding the motion and rotation of the mechanical arms 1010, 1020. The end segment is a stylus 1040 that can be manipulated to touch points on the dental impression 1080 held in the container 1090. The mechanical location device 1000 can be fixed to a common platform as the container 1090.

Accurate 3D positional and angular information of the points that the stylus touches can be decoded and output at the electronic output port 1070. Information about six degrees of freedom can be obtained by an additional decoder for self-rotation of the stylus. Additional sensors can be placed at the tip of the stylus to measure the hardness of the surface of the measurement object. Immersion Corp.'s MicroScribe uses a pointed stylus attached to a CMM-type device to produce an accuracy of 0.009 inches.

In measuring the tooth positions from the impression of the patient's teeth, the MicroScribe digitizer is mounted on a fixture fixed to a base plate. The device can communicate with a host computer via USB or serial port. The user then selects points of interest at each tooth positions in the impression and places the stylus at the point of interest. Positional and angular information are decoded and then transmitted to the computer. The Cartesian XYZ coordinates of the acquired points are then calculated and logged for each first feature location and orientation (or alternatively each tooth).

A user establishes a new coordinate system based on the container chamber in which the arch impression is held. The user establishes this system by taking readings for two points on two sides of the container to define the x axis. Another reading on the plane establishes the x-y plane. An origin is then determined on the x-y plane. The z axis will be established by taking the cross product of the x and y axes.

The user next selects a plurality of points on the surfaces of the arch impression corresponding to each tooth. The 3D points measured from the impression surfaces are then interpolated to create surfaces and solids integrated into an overall design.

The user will start reading the pin readings. For each tooth, the user will first take a reading that will establish the center of the two pins, and their orientation vector. Then the user will take two more points that will give us the direction to move from the center of the pins, and finally the dimensions and positions of two pins will be calculated using these values, and the pins will be visually rendered in the software. The user may fine tune these readings as required.

After the readings for each pin has been acquired, the first feature locations and orientations are saved, which can be further fine tuned and visualized. A digital dental arch model can include a plurality of digital tooth models. The digital dental model can be developed based on the first feature locations and orientations or alternatively the coordinates of the physical tooth models acquired by the mechanical location device. The exported data can be used to control CNC based drilling and milling.

The number of points defining the curves and number of curves depends on the desired resolution in the model. Surfacing functions offered by the design application are used to create and blend the model surfaces. The model may be shaded or rendered, defined as a solid or animated depending on the designer's intentions. The teeth are labeled so the order of the physical tooth models are can properly be defined for the physical dental arch model. All the readings acquired by the stylus can be rendered in real time to allow the user to visualize the digital tooth models. The coordinate axes and points can be rendered in the software using different colored cylinders/spheres etc. so as to distinguish the different meanings of values.

The detailed process for defining pin locations is as follows:

1. Establish a new coordinate system based on the arch impression-container chamber

a. Take 3D coordinate readings for two points (on the left and right side of the container) that will establish the x axis.

b. Take a number of readings on the plane that will be the x-y plane.

c. Calculate the circumcenter of these two sets of points on each side.

d. Find the midpoint of the circumcenter and mark it as our origin.

e. Establish the y axis by taking the perpendicular bisector of this line segment.

f. Establish the z axis by taking the cross product of the x and y axes.

2. Find out the highest point inside the container chamber.

a. Take readings for many points on the impression.

b. Use the max value of z as the highest point.

3. Acquire the pin readings for each tooth in the arch impression.

a. Take a reading that will establish the center of the two pins, and their orientation vector.

b. Take two more points that will give the direction to move from the center of the pins.

c. Calculate the dimensions and positions of two pins using the values above, and visually render the pins in the software.

d. Allow the user to fine tune these readings as required.

4. Save the data in a number of formats, including but not limited to csv (comma separated), XML, database based, or plain text file. The saved data will also be load-able in the software even when the Microscribe device is not available, for fine tuning and visualization. The exported data will be transformed by another set of software for eventual CNC drilling and milling.

Individual tooth model can be obtained in step 120 in a number of different methods. The tooth model can be created by casting. A negative impression is first made from a patient's arch using for example PVS. A positive of the patient's arch is next made by pouring a casting material into the negative impression. After the material is dried, the mold is then taken out with the help of the impression knife. A positive of the arch is thus obtained.

In an alternative approach, the negative impression of the patient's tooth arch is placed in a specially designed container. A casting material is then poured into the container over the impression to create a model. A lid is subsequently placed over the container. The container is opened and the mold can be removed after the specified time.

Examples of casting materials include auto polymerizing acrylic resin, thermoplastic resin, light-polymerized acrylic resins, polymerizing silicone, polyether, plaster, epoxies, or a mixture of materials. The casting material is selected based on the uses of the cast. The material should be easy for cutting to obtain individual tooth model. Additionally, the material needs to be strong enough for the tooth model to take the pressure in pressure form for producing a dental aligner. Details of making a dental aligner are disclosed in commonly and above referenced U.S. patent application titled “Method and apparatus for manufacturing and constructing a dental aligner” by Huafeng Wen, filed Nov. 1, 2004, the content of which is incorporated herein by reference.

Features that can allow tooth models to be attached to a base (step 140) can be added to the casting material in the casting process. Registration points or pins can be added to each tooth before the casting material is dried. Optionally, universal joints can be inserted at the top of the casting chamber using specially designed lids, which would hang the universal joints directly into the casting area for each tooth.

Still in step 120, individual tooth models are next cut from the arch positive. One requirement for cutting is to obtain individual teeth in such a manner that they can be joined again to form a tooth arch. The separation of individual teeth from the mold can be achieved using a number of different cutting methods including laser cutting and mechanical sawing.

Separating the positive mold of the arch into tooth models may result in the loss of the relative 3D coordinates of the individual tooth models in an arch. Several methods are provided in step 140 for finding relative position of the tooth models. In one embodiment, unique registration features are added to each pair of tooth models before the positive arch mold is separated. The separated tooth models can be assembled to form a physical dental arch model by matching tooth models having the same unique registration marks.

The positive arch mold can also be digitized by a three-dimensional scanning using a technique such as laser scanning, optical scanning, destructive scanning, CT scanning and Sound Wave Scanning. A physical digital dental arch model is therefore obtained. The physical digital dental arch model is subsequently smoothened and segmented. Each segment can be physically fabricated by CNC based manufacturing to obtain individual tooth models. The physical digital dental arch model tracks and stores the positions of the individual tooth models. Unique registration marks can be added to the digital tooth models that can be made into a physical feature in CNC base manufacturing.

Examples of CNC based manufacturing include CNC based milling, Stereolithography, Laminated Object Manufacturing, Selective Laser Sintering, Fused Deposition Modeling, Solid Ground Curing, and 3D ink jet printing. Details of fabricating tooth models are disclosed in commonly assigned and above referenced U.S. patent application titled “Method and apparatus for manufacturing and constructing a physical dental arch mode” by Huafeng Wen, filed Nov. 1, 2004, the content of which is incorporated herein by reference.

In another embodiment, the separated tooth models are assembled by geometry matching. The intact positive arch impression is first scanned to obtain a 3D physical digital dental arch model. Individual teeth are then scanned to obtain digital tooth models for individual teeth. The digital tooth models can be matched using rigid body transformations to match a physical digital dental arch model. Due to complex shape of the arch, inter-proximal areas, root of the teeth and gingival areas may be ignored in the geometry match. High precision is required for matching features such as cusps, points, crevasses, the front faces and back faces of the teeth. Each tooth is sequentially matched to result in rigid body transformations corresponding to the tooth positions that can reconstruct an arch.

In another embodiment, the separated tooth models are assembled and registered with the assistance of a 3D point picking devices. The coordinates of the tooth models are picked up by 3D point picking devices such as stylus or Microscribe devices before separation. Unique registration marks can be added on each tooth model in an arch before separation. The tooth models and the registration marks can be labeled by unique IDs. The tooth arch can later be assembled by identifying tooth models having the same registration marks as were picked from the Jaw. 3D point picking devices can be used to pick the same points again for each tooth model to confirm the tooth coordinates.

The base is designed in step 140 to receive the tooth models. The base and tooth models include complimentary features to allow them to be assembled together. The tooth model has a protruding structure attached to it. The features at the base and tooth models can also include a registration slot, a notch, a protrusion, a hole, an interlocking mechanism, and a jig. The protruding structure can be obtained during the casting process or be created after casting by using a CNC machine on each tooth.

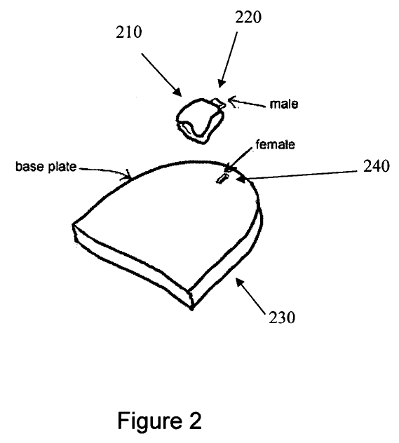

Before casting the arch from the impression, the base plate is taken through a CNC process to create the female structures for each individual tooth (step 150). Then the base is placed over the casting container in which the impression is already present and the container is filled with epoxy. The epoxy gets filled up in the female structures and the resulting mold has the male studs present with each tooth model that can be separated afterwards. FIG. 2 shows a tooth model 210 with male stud 220 after mold separation. The base 230 comprises a female feature 240 that can receive the male stud 220 when the tooth model 210 is assembled to the base 230.

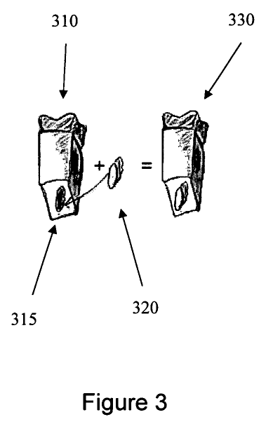

Alternatively, as shown in FIG. 3, a tooth model 310 includes a female socket 315 that can be drilled by CNC based machining after casting and separation. A male stud 320 that fits the female socket 315 can be attached to the tooth model 310 by for example, screwing, glue application, etc. The resulted tooth model 330 includes male stud 310 that allows it to be attached to the base.

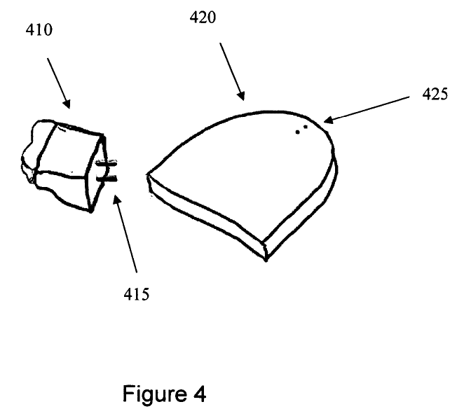

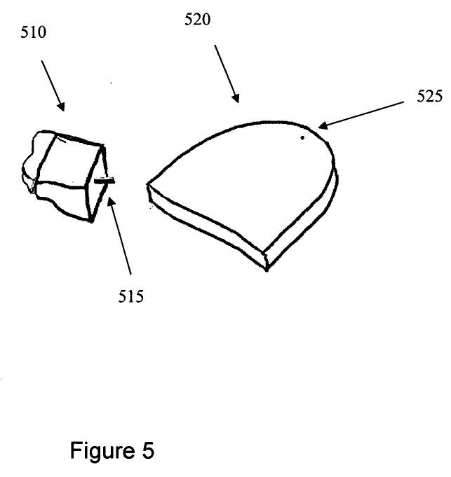

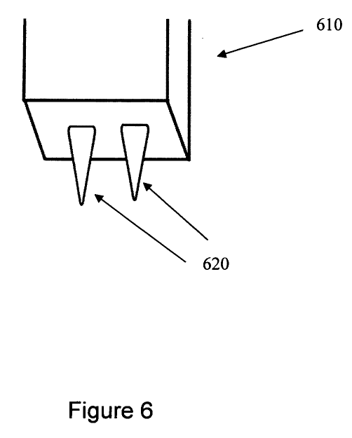

Male protrusion features over the tooth model can exist in a number of arrangements. FIG. 4 shows a tooth model 410 having two pins 415 sticking out and a base 420 having registration slots 425 adapted to receive the two pins 415 to allow the tooth model 410 to be attached to the base 420. FIG. 5 shows a tooth model 510 having one pins 515 protruding out and a base 520 having a hole 525 adapted to receive the pin 515 to allow the tooth model 510 to be attached to the base 520. In general, the tooth model can include two or more pins wherein the base will have complementary number of holes at the corresponding locations for each tooth model. The tooth model 610 can also include cone shaped studs 620 as shown in FIG. 6. The studs can also take a combination of configurations described above.

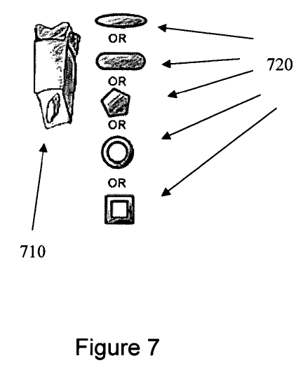

As shown FIG. 7, the studs protruding our of the tooth model 710 can take different shapes 720 such as oval, rectangle, square, triangle, circle, semi-circle, each of which correspond to slots on the base having identical shapes that can be drilled using the CNC based machining. The asymmetrically shaped studs can help to define a unique orientation for the tooth model on the base.

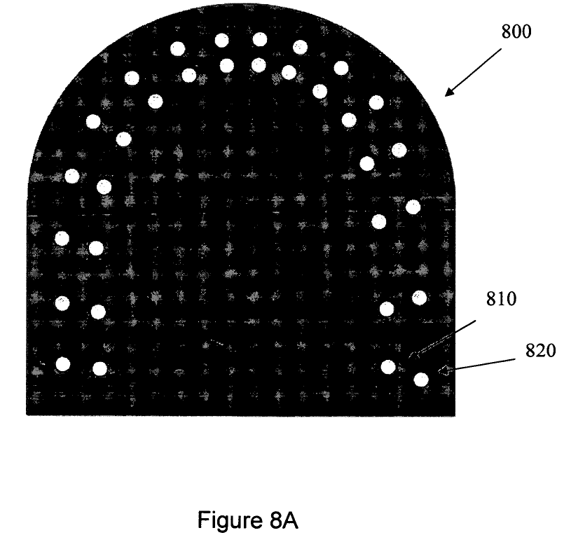

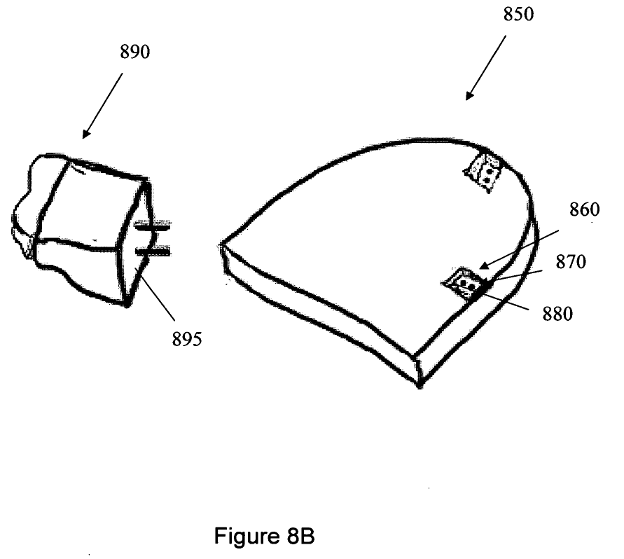

FIG. 8A shows a base 800 having a plurality of sockets 810 and 820 for receiving the studs of a plurality of tooth models. The positions of the sockets 810,820 are determined by either her initial teeth positions in a patient's arch or the teeth positions during the orthodontic treatment process. The base 800 can be in the form of a plate as shown in FIG. 8, including a plurality of pairs of sockets 810,820. Each pair of sockets 810,820 is adapted to receive two pins associated with a physical tooth model. Each pair of sockets includes a socket 810 on the inside of the tooth arch model and a socket 820 on the outside of the tooth arch model.

Another of a base 850 is shown in FIG. 8B. A plurality of pairs of female sockets 860, 870 are provided in the base 850. Each pair of the sockets 860, 870 is formed in a surface 880 and is adapted to receive a physical tooth model 890. The bottom portion of the physical tooth model 890 includes a surface 895. The surface 895 comes to contact with the surface 880 when the physical tooth model 890 is inserted into the base 850, which assures the stability of the physical tooth model 890 over the base 850.

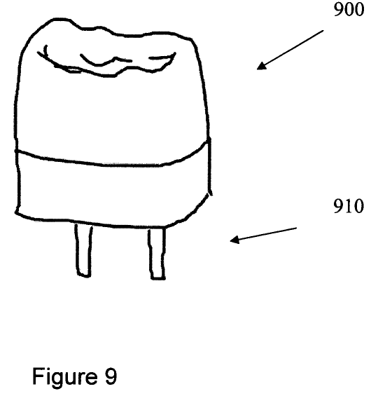

A tooth model 900 compatible with the base 800 is shown in FIG. 9. The tooth model 900 includes two pins 910 connected to its bottom portion. The two pins 910 can be plugged into a pair of sockets 810 and 820 on the base 800. Thus each pair of sockets 810 and 820 uniquely defines the positions of a tooth model. The orientation of the tooth model is also uniquely defined if the two pins are labeled as inside and outside, or the sockets and the pins are made asymmetric inside and outside. In general, each tooth model may include correspond to one or a plurality of studs that are to be plugged into the corresponding number of sockets. The male studs and the sockets may also take different shapes as described above.

A tooth arch model is obtained after the tooth models are assembled to the base 800 (step 160). The base 800 can comprise a plurality of configurations in the female sockets 810. Each of the configurations is adapted to receive the same physical tooth models to form a different arrangement of at least a portion of a tooth arch model.

The base 800 can be fabricated by a system that includes a computer device adapted to store digital tooth models representing the physical tooth models. As described above, the digital tooth model can be obtained by various scanning techniques. A computer processor can then generate a digital base model compatible with the digital tooth models. An apparatus fabricates the base using CNC based manufacturing in accordance with the digital base model. The base fabricated is adapted to receive the physical tooth models.

The physical tooth models can be labeled by a predetermined sequence that define the positions of the physical tooth models on the base 800. The labels can include a barcode, a printed symbol, hand-written symbol, a Radio Frequency Identification (RFID). The female sockets 810 can also be labeled by the parallel sequence for the physical tooth models.

In one embodiment, tooth models can be separated and repaired after the base. The tooth models can be removed, repaired or replaced, and re-assembled without the replacement of the whole arch model.

Common materials for the tooth models include polymers, urethane, epoxy, plastics, plaster, stone, clay, acrylic, metals, wood, paper, ceramics, and porcelain. The base can comprise a material such as polymers, urethane, epoxy, plastics, plaster, stone, clay, acrylic, metals, wood, paper, ceramics, porcelain, glass, and concrete.

The arch model can be used in different dental applications such as dental crown, dental bridge, aligner fabrication, biometrics, and teeth whitening. For aligner fabrication, for example, each stage of the teeth treatment may correspond a unique physical dental arch model. Aligners can be fabricated using different physical dental arch models one at a time as the teeth movement progresses during the treatment. At each stage of the treatment, the desirable teeth positions for the next stage are calculated. A physical dental arch model having modified teeth positions is fabricated using the process described above. A new aligner is made using the new physical dental arch model.

The system can also be used in conjunction with a casting chamber by receiving a negative impression of a patient's tooth in a casting chamber; pouring a casting material over the negative impression of the patient's tooth; solidifying the casting material wherein the casting material is attached to the lid of the casting chamber; and cutting a tooth portion off the solidified casting material to produce a reference base portion of the casting material attached to the lid of the casting chamber, wherein the reference base is configured to mold the physical tooth model. In another aspect, the method for producing a physical tooth model can include receiving a negative impression of a patient's tooth in a casting chamber; pouring a casting material over the negative impression of the patient's tooth; solidifying the casting material wherein the casting material is attached to the lid of the casting chamber; cutting a tooth portion off the solidified casting material to produce a reference base attached to the lid of the casting chamber, and producing first features in the reference base to assist the molding of the physical tooth model having second features complimentary to the first features using the reference base. The casting system for producing a physical tooth model can include a casting chamber configured to hold a negative impression of a patient's tooth and to receive casting material that can subsequently solidify in the casting chamber; a chamber lid configured to hold the solidified casting material and to produce a reference base by cutting off the tooth portion, wherein the reference base is adapted to mold the physical tooth model. More details on the casting chamber are disclosed in application Ser. No. ______ entitled “PRODUCING A PHYSICAL TOOTHMODEL COMPATIBLE WITH A PHYSICAL DENTAL ARCH MODEL”, the content of which is incorporated herewith.

In accordance with one aspect the present invention, each base is specific to an arch configuration. There is no need for complex and costly mechanisms such as micro-actuators for adjusting multiple degrees of freedom for each tooth model. The described methods and system is simple to make and easy to use.

The described methods and system are also economical. Different stages of the arch model can share the same tooth models. The positions for the tooth models at each stage of the orthodontic treatment can be modeled using orthodontic treatment software. Each stage of the arch model may use a separate base. Or alternatively, one base can be used in a plurality of stages of the arch models. The base may include a plurality of sets of receptive positions for the tooth models. Each set corresponds to one treatment stage. The tooth models can be reused through the treatment process. Much of the cost of making multiple tooth arch models in orthodontic treatment is therefore eliminated.

Although specific embodiments of the present invention have been illustrated in the accompanying drawings and described in the foregoing detailed description, it will be understood that the invention is not limited to the particular embodiments described herein, but is capable of numerous rearrangements, modifications, and substitutions without departing from the scope of the invention. The following claims are intended to encompass all such modifications.

What is claimed is:

1. A method for producing a base configured to receive physical models of teeth, comprising:
acquiring coordinates of the physical models in a physical dental arch model using a mechanical location device;
determining one or more configurations of one or more first features affixed to the physical models; and
determining one or more locations of one or more second features in the base in accordance with the coordinates of the physical models in the physical dental arch model and the configurations of the first features, wherein the second features are configured to receive the first features affixed to the physical tooth models.

2. The method of claim 1, further comprising fabricating a physical base using Computer Numerical Control (CNC), wherein the base comprises the second features at the locations in accordance with the coordinates of the physical tooth models in the physical dental arch model and the configurations of the first features affixed to the physical tooth models.

3. The method of claim 1, further comprising acquiring positions and orientations of the physical models from an impression of a patient's dental arch using a mechanical location device having one or more degrees of freedom.

4. The method of claim 3, wherein the mechanical location device comprises
a stylus configured to touch one or more points on the surface of the impression; and
a digital device configured to retrieve coordinates of the points touched by the stylus.

5. The method of claim 1, wherein acquiring the coordinates of the physical tooth models comprises
acquiring a coordinate of a reference point using the mechanical location device; and
acquiring one or more coordinates of one or more points of the physical model using the mechanical location device.

6. The method of claim 1, wherein determining the configurations of the first features affixed to the physical tooth models includes acquiring the coordinates of the first features affixed to physical models using a mechanical location device

7. The method of claim 1, wherein determining the configurations of the first features affixed to the physical tooth models includes acquiring the coordinates of the first features affixed to physical tooth models using a digital dental model representing the physical tooth models.

8. The method of claim 1, further comprising fabricating a physical base comprising the second features at the locations in accordance with the coordinates of the physical models in the physical dental arch model and the configurations of the first features affixed to the physical models.

9. The method of claim 1, further comprising
developing a digital dental arch model comprising a plurality of digital models in response to the coordinates of the physical tooth models acquired by the mechanical location device and the configurations of the first features affixed to the physical tooth models.

10. The method of claim 1, further comprising
fabricating the physical tooth models affixed with the first features having the configurations in response to the digital dental arch model.

11. The method of claim 1, further comprising
inserting the first features affixed to the physical tooth models into the corresponding second features in the base to form a physical dental arch model.

12. The method of claim 1, wherein the first features comprise one of a pin, a registration slot, a socket, a notch, a protrusion, a hole, an interlocking mechanism, a jig, and a pluggable feature and an attachable feature.

13. The method of claim 1, further comprising
measuring the positions of the physical tooth models in the physical dental arch model using a mechanical location device to determine positions adjustment of the second features in the base.

14. A method for producing a base configured to receive one or more physical tooth models, comprising:
acquiring one or more coordinates of the one or more physical tooth models in a physical dental arch model from an impression of a patient's arch using a mechanical location device; and
determining one or more locations of the one or more physical tooth models in the base in accordance with the one or more coordinates of the one or more physical tooth models in the physical dental arch model.

15. The method of claim 14, wherein one of the physical tooth models is affixed with first features and the base includes one or more second features configured to receive the one or more first features affixed to the physical tooth the models.

16. The method of claim 15, wherein a location of each of the second features in the base is determined by coordinates of the physical tooth models.

17. The method of claim 14, wherein the mechanical location device comprises
a stylus configured to touch a point in space; and
a digital device for retrieving coordinates of the point touched by the stylus.

18. The method of claim 14, wherein acquiring the coordinates of the physical tooth models comprises
acquiring coordinates of a reference point fixed to the impression of the patient's arch using the mechanical location device; and
acquiring the coordinates of one or more of the physical tooth models from the impression of the patient's arch using the mechanical location device.

19. A physical dental arch model, comprising:
one or two physical tooth models each comprising a tooth portion and two or more first features affixed to the bottom of the tooth portion; and
a base comprising a plurality of second features configured to receive first features affixed to the physical tooth models, wherein the locations of the second features are determined by the coordinates acquired from the impression of a patient arch using a mechanical location device.

20. The physical dental arch model of claim 19, wherein the base comprises a plurality of pairs of receiving sockets, wherein each pair of receiving sockets are configured to receive a physical tooth model affixed with two pins.
